(19) United States
(12) Patent Application Publication
(10) Pub. No.: US 2003/0066068 A1
(43) Pub. Date: Apr. 3, 2003

(54) Individual recommender database using profiles of others

(75) Inventors: Srinivas Gutta, Buchanan, NY (US); Kaushal Kurapati, Yorktown Heights, NY (US)

Correspondence Address: Corporate Patent Counsel;, U.S. Philips Corporation;, 580 White Plains Road;, Tarrytown, NY, 10591, US

(73) Assignee: Koninklijke Philips Electronics N.V.

(21) Appl. No.: 09/966,414

(22) Filed: Sep. 28, 2001

(51) Int. Cl. H04N 7/16; H04H 9/00; G06F 3/00; H04N 5/445; G06F 13/00

(52) U.S. Cl. 725/9; 725/46; 725/13; 725/14

(57) ABSTRACT

A data-class recommender, such an electronic program guide that recommends television programs, avoids users getting trapped in a rut when the users select the same programming material over and over again. In an embodiment, the recommender may be programmed automatically to leverage the profile of another user to broaden the user's profile. For example, the recommender may use the target descriptions of other users in a same household of the user as a guide for broadening the user's profile. Alternatively, the household profile may be used as a filter for source material for soliciting feedback from the user. In this way, rather than simply broadening the user's range arbitrarily, guidance from other profiles, related in some way to the user, is obtained and leveraged. Note that the “relationship” can include friends, published stereotypes representing interests of the user, and others.

### BACKGROUND OF THE INVENTION

1. Field of the Invention

The invention relates to search engines that learn a user's preferences by observing a user's behavior and filter a large space of data based on the observed preferences. Such systems employ algorithms to infer rules from user behavior rather than require a user to enter rules explicitly. The invention relates more particularly to search engines that make recommendation for an individual user based on both the user's choices and the choices of others.

### BACKGROUND

Search engines are becoming increasingly important in applications in which very large databases must be used efficiently and quickly. Search engines are useful not only for searching the worldwide Web, but for store catalogs, television programming, music listings, file systems, etc. In a world where the focus is shifting from information to knowledge, search engines are a huge growth area and have immense potential.

One way in which search engines are finding application is in so-called passive recommenders, which observe a user's selection behavior and make recommendations based on that behavior. This technique is used in connection with electronic program guides (EPGs) for selecting television programming.

Electronic program guides (EPGs) promise to make more manageable, the task of choosing from among myriad television and other media viewing choices. Passive search engines build user-preference databases and use the preference data to make suggestions, filter current or future programming information to simplify the job of choosing, or even make choices on behalf of the user. For example, the system could record a program without a specific request from the user or highlight choices that it recommends.

As mentioned above, one type of device for building the preference database is a passive one from the standpoint of the user. The user merely makes choices in the normal fashion from raw EPG data and the system gradually builds a personal preference database by extracting a model of the user's behavior from the choices. It then uses the model to make predictions about what the user would prefer to watch in the future. This extraction process can follow simple algorithms, such as identifying apparent favorites by detecting repeated requests for the same item, or it can be a sophisticated machine-learning process such as a decision-tree technique with a large number of inputs (degrees of freedom). Such models, generally speaking, look for patterns in the user's interaction behavior (i.e., interaction with the user-interface (UI) for making selections).

One straightforward and fairly robust technique for extracting useful information from the user's pattern of watching is to generate a table of feature-value counts. An example of a feature is the “time of day” and a corresponding value could be “morning.” When a choice is made, the counts of the feature-values characterizing that choice are incremented. Usually, a given choice will have many feature-values. A set of negative choices may also be generated by selecting a subset of shows (optionally, at the same time) from which the choice was discriminated. Their respective feature-value counts will be decremented (or a count for shows not watched incremented). These data are sent to a Bayesian predictor which uses the counts as weights to feature-counts characterizing candidates to predict the probability that a candidate will be preferred by a user. This type of profiling mechanism is described in U.S. patent application Ser. No. 09/498,271, filed Feb. 4, 2000 for BAYESIAN TV SHOW RECOMMENDER, the entirety of which is hereby incorporated by reference as if fully set forth herein. A rule-based recommender in this same class of systems, which build profiles passively from observations of user behavior, is also described in the PCT application, WO 99/01984 published Jan. 14, 1999 for INTELLIGENT ELECTRONIC PROGRAM GUIDE.

Another example of the first type is MbTV, a system that learns viewers' television watching preferences by monitoring their viewing patterns. MbTV operates transparently and builds a profile of a viewer's tastes. This profile is used to provide services, for example, recommending television programs the viewer might be interested in watching. MbTV learns about each of its viewer's tastes and uses what it learns to recommend upcoming programs. MbTV can help viewers schedule their television watching time by alerting them to desirable upcoming programs, and with the addition of a storage device, automatically record these programs when the viewer is absent.

MbTV has a Preference Determination Engine and a Storage Management Engine. These are used to facilitate time-shifted television. MbTV can automatically record, rather than simply suggest, desirable programming. MbTV's Storage Management Engine tries to insure that the storage device has the optimal contents. This process involves tracking which recorded programs have been viewed (completely or partially), and which are ignored. Viewers can “lock” recorded programs for future viewing in order to prevent deletion. The ways in which viewers handle program suggestions or recorded content provides additional feedback to MbTV's preference engine which uses this information to refine future decisions.

MbTV will reserve a portion of the recording space to represent each “constituent interest.” These “interests” may translate into different family members or could represent different taste categories. Though MbTV does not require user intervention, it is customizable by those that want to fine-tune its capabilities. Viewers can influence the “storage budget” for different types of programs. For example, a viewer might indicate that, though the children watch the majority of television in a household, no more than 25% of the recording space should be consumed by children's programs.

A second type of device is more active. It permits the user to specify likes or dislikes by grading features. These can be scoring feature-value pairs (a weight for the feature plus a value; e.g., weight=importance of feature and value the preferred or disfavored value) or some other rule-specification such as favorite programs, combinations of feature-value pairs like “I like documentaries, but not on Thursday which is the night when the gang comes over.” For example, the user can indicate, through a user interface, that dramas and action movies are favored and that certain actors are disfavored. These criteria can then be applied to predict which, from among a set of programs, would be preferred by the user.

As an example of the second type of system, one EP application (EP 0854645A2), describes a system that enables a user to enter generic preferences such as a preferred program category, for example, sitcom, dramatic series, old movies, etc. The application also describes preference templates in which preference profiles can be selected, for example, one for children aged 10-12, another for teenage girls, another for airplane hobbyists, etc.

A third type of system allows users to rank programs in some fashion. For example, currently, TIVO® permits user's to give a show up to three thumbs up or up to three thumbs down. This information is similar in some ways to the second type of system, except that it permits a finer degree of resolution to the weighting given to the feature-value pairs that can be achieved and similar to the first type except the expression of user taste in this context is more explicit. (Note, this is not an admission that the Bayesian technology discussed in U.S. patent application Ser. No. 09/498,271 combined with user-ranking, as in the third type of system, is in the prior art.)

A PCT application (WO 97/4924 entitled System and Method for Using Television Schedule Information) is an example of the third type. It describes a system in which a user can navigate through an electronic program guide displayed in the usual grid fashion and select various programs. At each point, he/she may be doing any of various described tasks, including, selecting a program for recording or viewing, scheduling a reminder to watch a program, and selecting a program to designate as a favorite. Designating a program as a favorite is for the purpose, presumably, to implement a fixed rule such as: “Always display the option of watching this show” or to implement a recurring reminder. The purpose of designating favorites is not clearly described in the application. However, more importantly, for purposes of creating a preference database, when the user selects a program to designate as a favorite, she/he may be provided with the option of indicating the reason it is a favorite. The reason is indicated in the same fashion as other explicit criteria: by defining generic preferences.

The first type of system has the advantage of being easier on the user since the user does not have to provide any explicit data. The user need merely interact with the system. For any of the various machine-learning or predictive methods to be effective, a substantial history of interaction must be available to build a useful preference database. The second and third types have the advantage of providing explicit preference information. The second is reliable, but not perfect as a user may have a hard time abstracting his own preferences to the point of being able to decide which criteria are good discriminators and what weight to give them. The third does not burden the user and probably provides the best quality of information, but can be a burden to generate and still may not contain all the information that can be obtained with the second and also may require information on many shows like the first.

One of the problems with prior art techniques for building preference databases manifests when a user repeatedly watches the same program. A large percentage of the user's choices are made up of too small a set of data and rules extracted from these choices end up defining an overly narrow range of recommendations. The problem is akin to falling into a rut. Another problem with prior art techniques is that they do not permit the easy sharing of implicit profiles among users. If a user likes the recommendations of a friend, there is no good way for the user to obtain some or all parts of his/her friend's profile and combine it in some way with his/her own.

### SUMMARY OF THE INVENTION

The invention provides mechanisms to expand the choices provided by a user's preference profile based on the preferences of others, particularly those of users in the same household. Various types of mechanisms for generating and refining a selection engine based on positive and/or negative examples are known. One, called a version space algorithm, saves two descriptions of all the possible choices available in a database (i.e., the “choice space”: (1) a general description that is the broadest description of the choice space excludes all negative choices and (2) a specialized description that is the narrowest description that embraces all positive examples in the choice space. Each time a negative or positive example is provided, it is used to alter the specialized or generalized description accordingly. The algorithm and further details on the version space algorithm is described in U.S. patent application Ser. No. 09/794,445 entitled “Television Programming Recommendations Through Generalizations And Specialization Of Program Content,” which is hereby incorporated by reference as if fully set forth herein in its entirety.

In the sphere of television program selection, the generalized description indicates all the possible programming choices that a user might be interested in. The specialized description indicates all the possible programming descriptions the user is clearly interested in. The range of descriptions between the generalized and specialized descriptions can be great. Also, the generalized description can be too liberal to reduce a large set of selections to a reasonable number and the specific description can be overly narrow for being trapped by a narrow range of examples.

The prior art has offered other ways to bump a user out of this mess. One is to select program content at random from the large space defined by the generalized description and ask the user to rank them. But this can lead to pretty stupid exercises. For example, suppose the only examples provided are English-language examples. The user has given no negative examples of content in the space of non-English descriptions. But most users are likely to be disinclined to expand their language horizons by watching television. Thus, a random selector would grab examples outside the English language space and ask the user to rank them only to get criteria that are marginally useful. That is, did the user not like it because it was about cars or because it was in the Spanish-language? A user would be quick to become bored if he were asked to rank too many irrelevant choices. It would be better to pull examples from a narrower description than the user's generalized description. According to the invention, this may be done by leveraging the specialized description or descriptions of others who are similar to the user according to some criterion, for example, users in the same household.

In one embodiment, a generalized-specialized description is defined that embraces the entire space of specialized descriptions of one or more other persons selected by the user. This generalized-specialized description is used as a source filter for generating test-samples with respect to which the user's positive and negative feedback is solicited. In another embodiment, a group is defined automatically, such as all the users in a household, and a new specialized description generated that is the narrowest to embrace the spaces defined by all the specialized descriptions. Test-samples are similarly derived from the new specialized space.

In a refinement of both of the above embodiments, priority is given to test-samples that discriminate ambiguous dimensions in the user's specialized description. That is samples from the generalized-specialized description that conform to the user's specialized description already are avoided and samples that are outside that description are favored. The latter samples clearly have higher discriminating power in the dimensions along which the user's specialized description is confluent with that of the generalized-specialized description.

Another refinement of the above approaches is to use the user's generalized description to specialize the generalized-specialized description. Because the generalized description is the storehouse of what the user doesn't like, it can be used as a filter to filter the space of the generalized-specialized description.

In another embodiment, classes of users are defined and, in a manner akin to collaborative filtering, the user's specialized description is generalized to embrace the space of the specialized descriptions of archetypal users. For example, a service provider may generate specialized descriptions for stereotypes such as: “sports fanatic,” “blood and guts,” “history geek,” “mawkishly sentimental,” “science lover,” and “fantasy lover.”

In yet another embodiment, rather than use other specialized descriptions to create a source for feedback to refine the user's descriptions, a new specialized description is created leveraging other specialized descriptions. In other words, the generalized-specialized description is substituted for the specialized description of the user.

In a user interface supporting an embodiment in which the user's specialized description is substituted for the generalized-specialized description, the user may be asked to try a stereotype out for a period of time. The old specialized description may be retrieved if the user did not like the result. Optionally, the user may retain the benefit of feedback obtained while the stereotypic description was applied to generalize the user's specialized description.

The invention can be extended to other types of induction engines. For example, neural networks can be trained on predictions from other networks to generalize their predictions of likes and dislikes. Decision trees can be expanded by known techniques such as by adding samples generated by another decision tree or more directly by sharing branches from another decision tree. Other types of machine learning, even ones as yet unknown, can also use the basic ideas behind the invention and should be within the competence of one skilled in the art in combination with the teachings in the present application.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is an illustration of a concept space for purposes of describing one type of induction engine in which the present invention may be implemented.

FIGS. 2A-2C are illustrations of the aggregation of data from two specialized descriptions to form either a source filter for generating feedback or a new specialized description to be substituted for that of a user.

FIGS. 3A-3D are illustrations representing the aggregation of generalized and specialized descriptions with the specialized description of another user to form a source filter for test target-data.

FIGS. 4A and 4B illustrate selection of a label for a specialized description feature.

FIG. 5 is an illustration of an example hardware environment for implementing the invention.

FIG. 6 is an illustration of a first type of feature-value-score type of profile engine and use.

FIG. 7 is an illustration of a second type of feature-value-score type of profile engine and use.

### DETAILED DESCRIPTION OF THE PREFERRED EMBODIMENTS

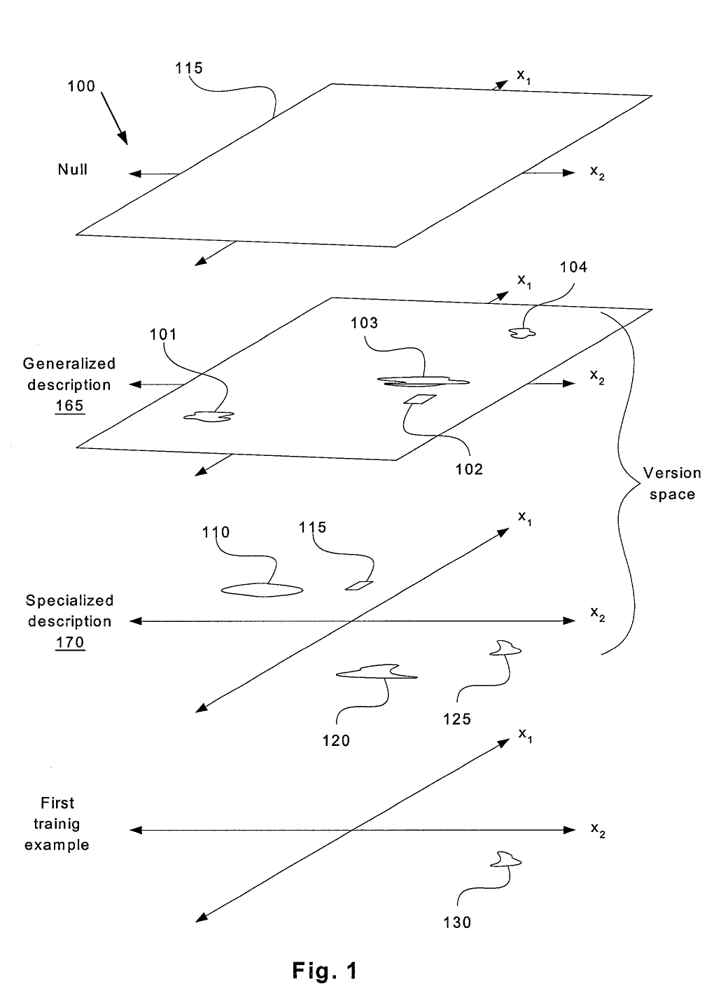

Referring to FIG. 1, a concept space 100 is defined in terms of a description formalism. For example, FIG. 1 is suggestive of a frame-based data structure or representation language using a Venn-type representation for the values in each frame-slot. For purposes of discussion, the large number of slots in the frame-based structure are represented as two axes, x₁ and x₂ which represent descriptor components, such as a slot in a frame-based structure. It is to be understood that the slots chosen may represent any parameters and the diagram is not intended to suggest that they are independent or that there is any limit on their number. For example, axis XI could represent type of television show (comedy, drama, horror, sports, etc.) and x₂ could represent actors (Tom Cruise, Shelly Duvall, Robert Wagner, etc.) For purposes of discussion, it can be imagined that there are many different descriptor components, each of which may take on one or more values or ranges of values and each of which may or may not be dependent of another descriptor component.

A universe of possible descriptions (the concept space 100) is limited only by the inherent bias of the formalism. Here, every possible description is contained in a null generalized description 115 at the highest level of a concept space. Before any learning has occurred, this singleton generalized description 115 embraces every possible example. At the lowest level of the concept space is a singleton which embraces only the first positive example 130 provided by a user.

After training for a period of time with positive and negative examples, for example using the version space algorithm described in the application incorporated by reference above, a most recent specialized description 170 is broadened so that it is the narrowest set of descriptions that encompasses all positive examples. By definition, it excludes all negative examples. Also, after training, a current generalized description 165 has been derived from the null generalized description 115 that is the broadest set of possible descriptions that does not contain any of the negative examples. By definition, this contains all positive examples.

Selections from the space of selections defined by the current specialized description 170 include only selections that are similar to previous positive examples. Thus, if recommendations are derived from the current specialized description 170, the recommendations will be too narrow and the user will be stuck in his/her rut for having given positive feedback on too narrow a set of examples. In such a case, the user may also have too broad a generalized description, so the generalized description may be too broad a space to expand into. There is a space, called the version space 101 lying between these extremes which defines the possible descriptions for subject matter the user might like with certainty increasing as one moves from the generalized description toward the specialized description.

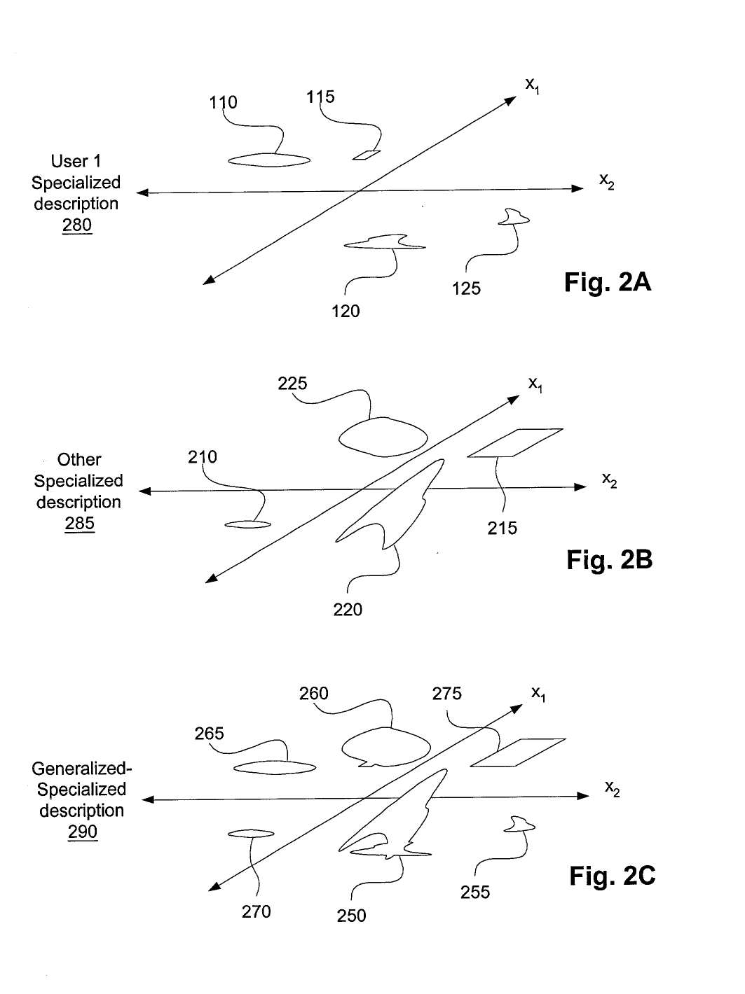

Referring now to FIGS. 2A-2C, a new specialized description 290 is derived from the union of the user's specialized description 280 with another specialized description 285. The latter may be, for example, a stereotype description or one of another user. Here the user's set which is the union of domains 110, 115, 120, and 125 is combined with the other set, which is the union of domains 210, 215, 220, and 225. The result is the set defined by the union of contiguous domains 250, 255, 260, 265, 270, and 275 shown in FIG. 2C. More precisely, the new description is the user's specialized description 280 generalized so as not to exclude subject matter that is embraced by the other specialized description 285. Note that, preferably, the generalized-specialized domain includes the multiple other specialized domains of other users in a same household as the user. It has been found that expanding in a manner consistent with the other household users provides better predictions than a user's own profile.

The use of additional user profiles to expand a profile that is mired in a rut can be made selectable by the user. The user may be provided with the option of selecting a group of user profiles, a stereotyped profile, or one or more specific profiles to be used to expand the user's options. The other profiles may be used to modify the user's profile permanently or simply to expand the range of selections on a use-by-use basis. Another possibility is for the learning engine to detect when a user's profile has fallen into a rut and take corrective action, such as by adding the specialized description of all members of a household. This can be determined in various ways according to the type of profile. For example in a feature-value-score-type profile, a profile with only a small number of feature-value-score records could be identified as in a rut. In a concept space, a specialized description that is highly specialized would indicate the profile is in a rut. Note that it may be appropriate to distinguish household members of the same age and only share descriptions when the members are in a similar age category.

As is known in the prior art, a system can solicit feedback on new examples selected at random. However, such a strategy can be impractical because it may include material for which negative feedback has been provided and could just include too large a space of possible subject matter. There is a high likelihood that mostly negative examples will be found and the user would likely become frustrated and lose interest. Alternatively, the current generalized description 165 could be used as a filter for new examples. However, the current generalized description 165 may still define too large a space of possibilities to be practical.

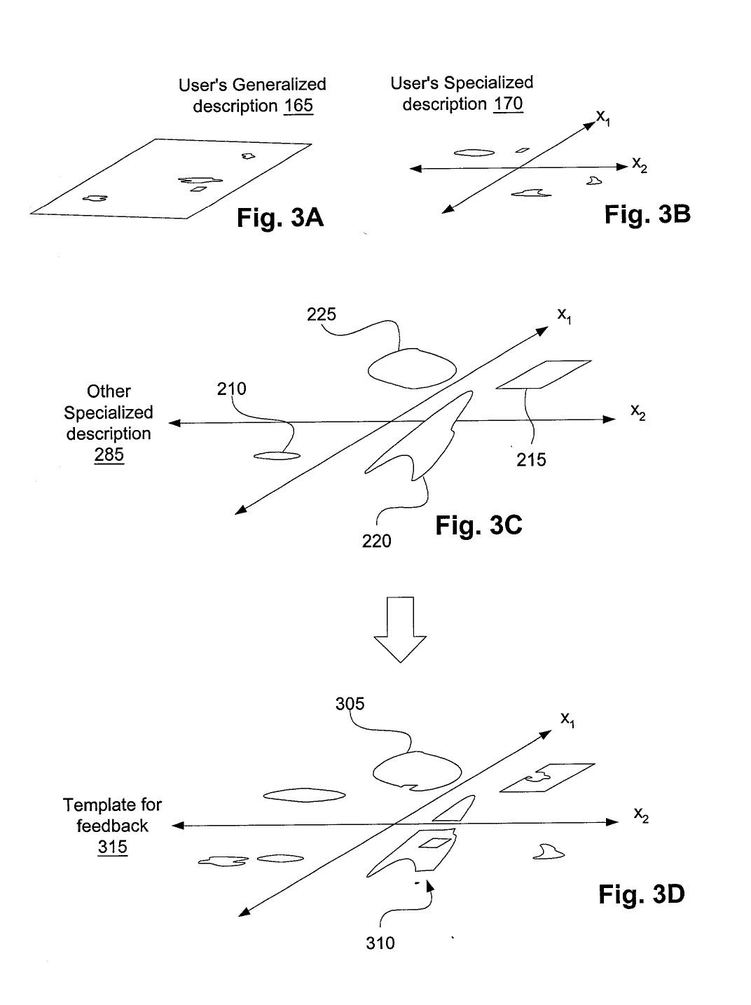

One approach to this problem is to use the specialized description of another user as a filter for soliciting feedback. The system may use the specialized description of another user's profile as a filter for selecting new material and request the user's feedback on that new material. Referring to FIGS. 3A-3D, it is preferred that the material for which the user has already given feedback be excluded from test-examples. Thus, the corresponding portions in the user's generalized description 165 and the user's specialized description 170 may be removed from the other specialized description 285 to provide a new template for feedback 315. Although only one other specialized description 170 is shown in the figures, it is clear that the union of any number of specialized descriptions could also be used to generate a template for feedback.

One important issue relating to permitting a user to use the profiles of others to enhance his/her own profile is giving the user some sense of control over the process. Probably the dominant concern here is making it clear to the user what s/he may do. In some cases, the leveraging of other profiles may be done transparently. For example, rather than relying solely on a user's individual profile, a recommender may include recommendations that are derived from the profiles of other users in the same household as the user. This can be done part of the time or all of the time. Of course, whenever feedback is obtained, it may be used to refine the profile of the individual user.

Although the above discussion employed figurative terms and drawings suggested by version space algorithms, the invention is applicable to other types of recommender systems as well. Suppose a first user likes the examples recommended by the profile of another user. One way to permit the first user to modify his own profile using the other user's profile is to use the other user's profile to generated suggested shows using the other user's profile and permit the first user to give feedback on them. This could be done without their being any compatibility between the recommendation engines.

Another strategy for expanding a user's profile is to substitute the generalized description of another user for the generalized description of the user.

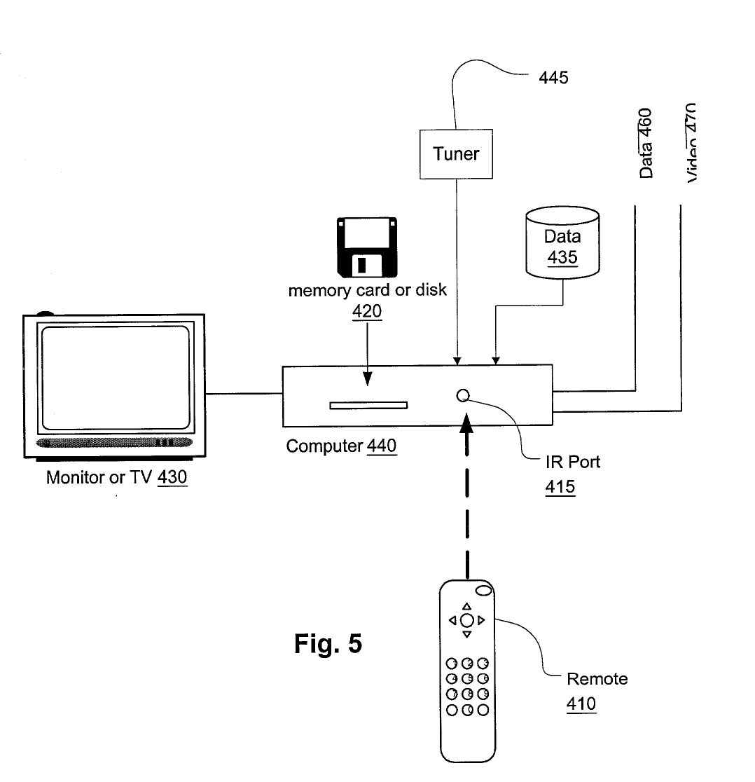

Referring to FIG. 5, an example of a hardware environment that may support the present invention includes a computer 440 equipped to receive the video signal 470 and control the channel-changing function, and to allow a user to select channels through a tuner 445 linked to the computer 440 rather than through the television's tuner 430. The user can then select the program to be viewed by highlighting a desired selection from the displayed program schedule using the remote control 410 to control the computer. The computer 440 has a data link 460 through which it can receive updated program schedule data. This could be a telephone line connectable to an Internet service provider or some other suitable data connection. The computer 440 has a mass storage device 435, for example a hard disk, to store program schedule information, program applications and upgrades, and other information. Information about the user's preferences and other data can be uploaded into the computer 440 via removable media such as a memory card or disk 420.

Note that many substitutions are possible in the above example hardware environment and all can be used in connection with the invention. The mass storage can be replaced by volatile memory or non-volatile memory. The data can be stored locally or remotely. In fact, the entire computer 440 could be replaced with a server operating offsite through a link. Rather than using a remote control to send commands to the computer 440 through an infrared port 415, the controller could send commands through a data channel 460 which could be separate from, or the same as, the physical channel carrying the video. The video 470 or other content can be carried by a cable, RF, or any other broadband physical channel or obtained from a mass storage or removable storage medium. It could be carried by a switched physical channel such as a phone line or a virtually switched channel such as ATM or other network suitable for synchronous data communication. Content could be asynchronous and tolerant of dropouts so that present-day IP networks could be used. Further, the content of the line through which programming content is received could be audio, chat conversation data, web sites, or any other kind of content for which a variety of selections are possible. The program guide data can be received through channels other than the separate data link 460. For example, program guide information can be received through the same physical channel as the video or other content. It could even be provided through removable data storage media such as memory card or disk 420. The remote control 410 can be replaced by a keyboard, voice command interface, 3D-mouse, joystick, or any other suitable input device. Selections can be made by moving a highlighting indicator, identifying a selection symbolically (e.g., by a name or number), or making selections in batch form through a data transmission or via removable media. In the latter case, one or more selections may be stored in some form and transmitted to the computer 440, bypassing the display 170 altogether. For example, batch data could come from a portable storage device (e.g. a personal digital assistant, memory card, or smart card). Such a device could have many preferences stored on it for use in various environments so as to customize the computer equipment to be used.

Some types of profiling mechanisms permit their internal target descriptions to be displayed as abstractions. For example, it would be possible in a frame-based data structure to actually allow one user to inspect another user's profile by associating titles with the different slots. Although the influence of a choice in any one slot can influence allowed choices in other slots, because the slots are not independent, it is not necessarily a straightforward task to present to a user a meaningful view of how a profile is constructed. For example, a user's profile may contain a specialized description that suggests the actor Tom Cruise is favored by the user. But the examples for which positive feedback was given are restricted to action-type movies. Thus, it cannot be said that the user likes Tom Cruise. It may be that the user only likes Tom Cruise in certain types of movies. The above example is simple. The real examples could be very complex and therefore make it difficult to present to user. The interface would have to show all the linked slots with any slot of interest thereby defining a multiple-parameter space. But consider that the goal is not to be 100% precise. The goal may be simply to permit the user to borrow only certain aspects of another user's profile and characterizing that aspect may not have to be so complete. The system could offer to modify a user's profile based on a particular slot that is coupled with many other slots by tagging the modification based on the values in only one slot. Thus, if the system indicated to a first that a second user's profile showed a marked preference for Tom Cruise, the first user, in accepting a modification to his/her own profile based on that preference, could expand his/her profile so that it recommended Tom Cruise examples coupled with all the attendant caveats implicit in the second user's profile. In other words, in the example given, the first user would be asked if s/he wants Tom Cruise and s/he would get Tom Cruise, but only Tom Cruise in action movies.

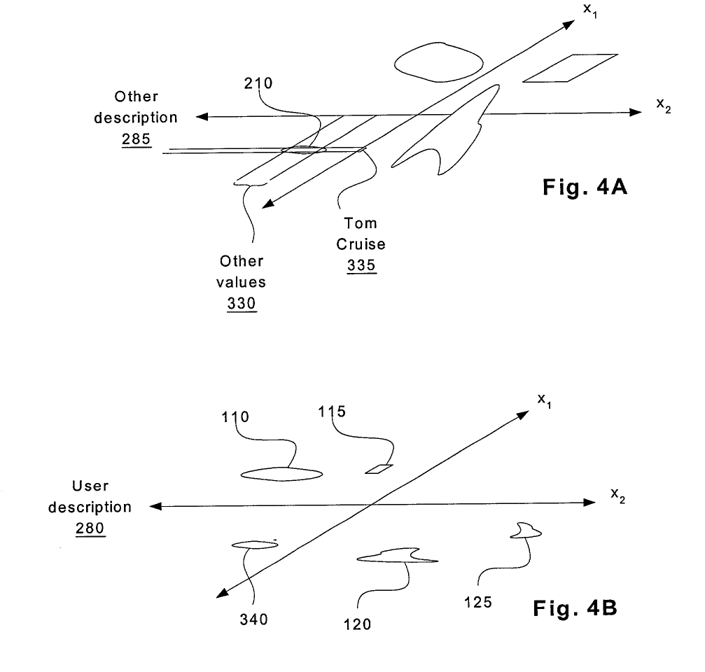

Determining labels such as “Tom Cruise” for the features of a user's profile, in a frame-based data structure conditioned under the version space algorithm, could be identified by selecting a value (e.g., “Tom Cruise” that appears in combination many times with values in other slots. In other words, there is a high incidence of that slot-value in the specialized description. This mechanism for permitting a user to control the porting of description information from one profile to another is illustrated in FIGS. 4A and 4B. Here, a user's description, which could be, for example, the user's specialized description, is scanned and various portions of it labeled according to a dominant feature. Shown in the figure is the labeling of a portion 210 as “Tom Cruise.”

Figuratively speaking, one dimension of the data structure x₁ may correspond to actor. The other dimension, x₂, may be considered to correspond to other parameters such as type of movie or any other. The value “Tom Cruise” has been selected in association with multiple values of other parameters so it may be inferred that it is an important feature-value.

Note that although the portion 210 of the description is shown as a contiguous closed space, as are the other portions in the other figures, which suggests contiguous ranges, such a feature may or may not represent how data is represented in a target description. In a frame-based model, each feature or slot may take on discrete values and there may be no relationship between adjacent features such that data sets would tend to form closed spaces such as 210. This is merely an abstraction borrowed for purposes of discussion. The only aspect of the closed space is that its length in the dimension indicated at 330 is suggestive of the fact that the value “Tom Cruise” is associated with multiple values of the other feature along dimension x₂ suggesting its importance.

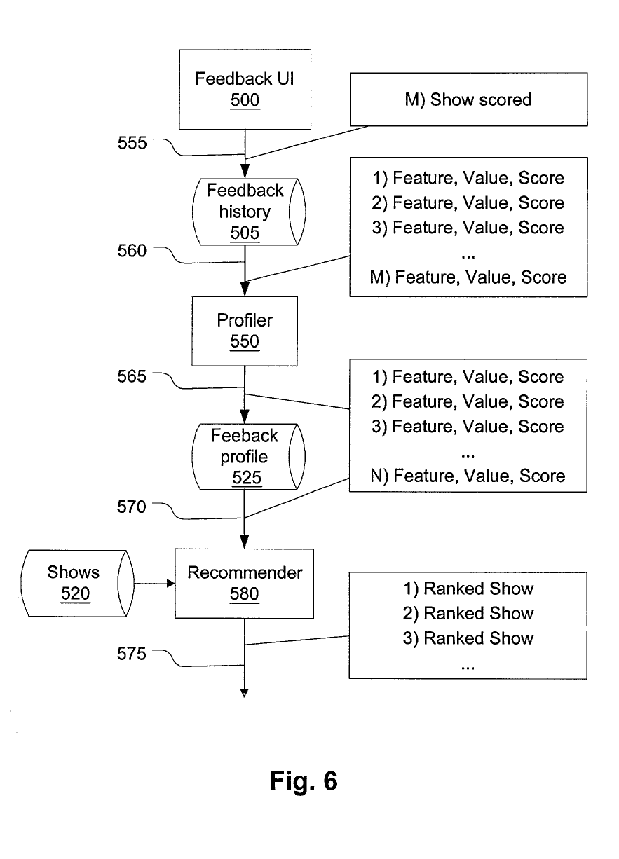

In other types of data structures, mechanisms for labeling portions of a profile would be readily identified. For example, in systems that store feature-value pairs labeling an important feature and porting that feature to another profile is even easier. Referring to FIG. 6, in such a system the user provides feedback to rank a choice as liked or disliked and, optionally, includes a degree of like or dislike. For example, a system may use a score from 1-7 with 4 being neutral, 1-3 representing degrees of dislike and 5-7 representing degrees of liking. A user interface (UI) 500 is used to list programs and accept the feedback information. Alternatively, the UI 500 may be a simple prompt that requests the user to give feedback on a program when the program either ends or when the user switches away from the program. Preferably, the prompt-type would be subject to a preference set that would allow the user to override the prompting in some or all situations if desired.

The information generated by each instance of the feedback UI 500 is one or more choices (shows, if it is a television database) 555 with a score associated with the choice. This is used to charge a feedback history file 505 which can contain a large number of such entries. The feedback data 560 may then be applied to a profiler 550. Alternatively the data can be stored in reduced form by reducing it in a profiler 550 first and then storing in a feedback profile database 525. The reduction may be a set of feature-value pairs 465, each with a ranking as described in Ser. No. 09/498,271, filed Feb. 4, 2000 for BAYESIAN TV SHOW RECOMMENDER. A given choice may give rise to a number (M) feature value pairs 565 with corresponding scores. Preferably, the user rates programs that are both liked and disliked so that both positive and negative feedback are obtained. If only positive feedback is acquired, say because feedback is only provided for programs selected for viewing, then the negative factors may not populate the database. This can be improved then, by having the system generate a set of negative choices by selecting a subset of shows available at the same time the choice was made. Preferably, as stated, the user provides a balance of positive and negative feedback and the automatic sampling of negative choices is not required. Their respective feature-value counts would be decremented. This data stored over many choices may be stored in the feedback profile 525 database. The entire body of N records 555 is then available when the recommender 580 makes recommendations based on a list of candidates derived from a show database 520. The end result of this process is a filtered or sorted list 575 of choices available from the show database 520. The recommender may be a Bayesian filter or any other predictor.

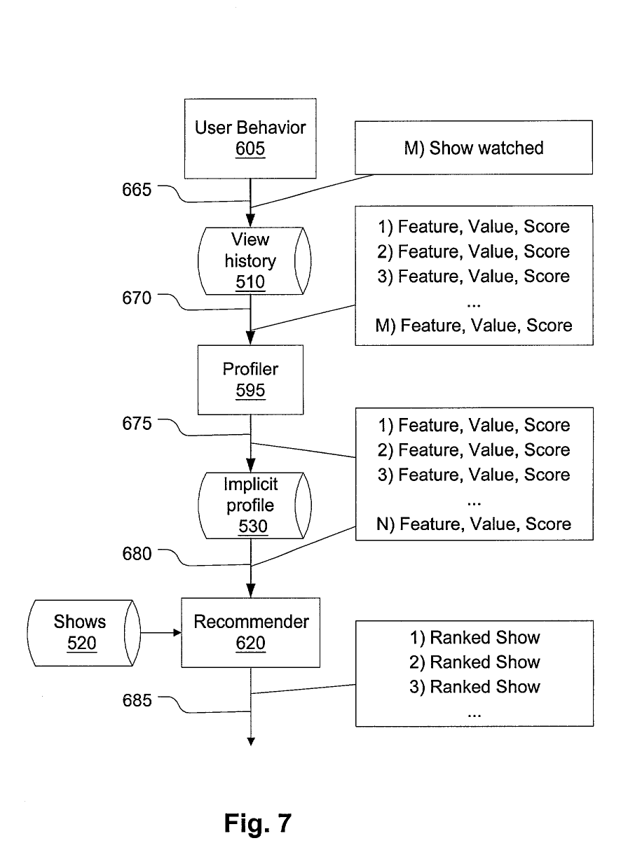

Referring to FIG. 7, a very similar process as in FIG. 6 may be used to generate a feature-value pair profile database. This predictor is of the first type described in the background section. Here, a user's selection of a program choice is inferred to indicate a positive score for a program choice. The result of a given choice by a user is a particular program 665 optionally with an attending score. This result can also include a score which may be inferred from the way the user responded. If the user watched the program to completion, the score may be high and if watched for only a short time, the score could be negative. If the program were watched for a period between these two, the score could be a middle magnitude. Alternatively, a watched program could receive a positive score and a random sample of unwatched programs (optionally, at the same time) a negative score.

The view history database 510 stores the shows and scores. The records 670 are supplied to a profiler 595 which generates feature-value pairs with attending scores 675, which may be stored in an implicit profile database 530. The contents 680 of the implicit profile database 530 are then available to a recommender 620 which combines them with data from current shows 520 to generate recommendations 685.

In this type of profiler, the lack of coupling of features makes uncomplicated the problem of labeling the parts of the data that may be ported from one profile to another. Thus, the feature “actor” and value “Tom Cruise” would be easy to identify as standing out in a target profile. This is because that feature-value pair would have a high score associated with it. A user could be offered the option of selecting that aspect of another user's profile for porting over into his/her profile. The result would be an adjustment of the score associated with the corresponding feature-value pair in the user's profile.

Combining the feature-value-score type data to broaden a user whose profile is in a rut would be a matter of, in the rutted user's profile, raising the scores of feature-value pairs that have high scores in the non-rutted user's databases. Again, a user interface could be generated to allow the rutted user to select the feature-values to be modified. Alternatively, the user could permit it to be done blindly. Yet another alternative to allow the change to be done only temporarily to try the change out. Another way to handle the falling-into-a-rut problem is to adjust any very strong scores associated with a user's profile. This could be done selectively by the user. The user interface could indicate to the user what feature values have very strong scores (either positive or negative) and permit the user to modify them.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

For example, although the invention was discussed with reference to a television recommender, it is clear it is applicable to any kind of media or data for which a search engine might be used. Thus, for example, the invention could be used in the context of an Internet search tool, or search engine for a music database.

What is claimed is:

1. A method of modifying a first user's user profile for a data-class recommender, comprising the steps of:
receiving feedback from a first user scoring examples falling into various data-classes;
refining said first user's user profile responsively to a said feedback;
modifying said first user's user profile responsively to data from a second user's user profile;
said step of modifying including modifying such that a frequency of recommendations of at least one data-class is increased without decreasing a frequency of recommendations of any other data-classes, whereby said first user's user profile is expanded in scope according to preferences stored in said second user's user profile.

2. A method as in claim 1, wherein said first user's user profile includes a specialized target description of favored data-classes and said step of modifying includes generalizing said specialized target description such that it encompasses at least one specialized target description of said second user's user profile.

3. A method as in claim 2, wherein said step of modifying includes substituting at least a union of specialized descriptions of said first user's user profile and said second user's user profile for said specialized description of said first user's user profile.

4. A method as in claim 1, wherein said step of generalizing includes substituting at least a union of specialized descriptions of said first user's user profile and said second user's user profile for said specialized description of said first user's user profile.

5. A method of modifying a first user's user profile for a data-class recommender, comprising the steps of:
receiving feedback from a first user scoring examples falling into various data-classes;
refining said first user's user profile responsively to a said feedback;
selecting test-data for revising said first user's user profile responsively to data from at least a second user's user profile;
requesting feedback on said test-data from said first user and modifying said first user's user profile responsively to said feedback.

6. A method as in claim 5, wherein said step of selecting includes selecting only test-data for which feedback incorporated in said first user's profile increases a discriminating power of said first user's user profile.

7. A method as in claim 7, wherein said selecting includes selecting primarily test-data for which said first user's user profile is insufficient for said recommender to determine whether said test-data would be favored or disfavored.

8. A method as in claim 5, wherein said step of selecting includes filtering a universe of data choices through a specialized description of a concept space.

9. A data-class recommender, comprising:
a learning engine;
a user interface device connectable to said learning engine;
said learning engine being connectable to a data source containing descriptions of data selections;
said learning engine being programmed to receive, through said user interface, feedback from a first user evaluating said data selections and to progressively generate a description of data selections that are favored and disfavored by said first user, thereby generating a first user profile;
said learning engine being further programmed to generate recommendations of data selections for said first user responsively to said first user profile;
said learning engine being further programmed to selectively generate recommendations of data selections for said first user responsively to said first user profile and at least a second user profile of a second user.

10. A method as in claim 9, wherein said learning engine is programmed such that said first user profile includes a narrow description defining target data selections and a broad description defining non-target data selections, the recommendations being derived from a space of selections lying between said broad and narrow descriptions.

11. A method as in claim 9, wherein said learning engine is programmed such that said first user profile includes at least a narrow description defining target data selections and said learning engine is further programmed to compare a level of narrowness in said narrow description to a threshold such that said first user profile results in recommendations embracing a range of target data that is narrower than said threshold and said learning engine is further programmed to selectively generate recommendations of data selections for said first user responsively to said first user profile and said at least a second user profile responsively to a result of so-comparing said level with said threshold.
